(19) United States
(12) Patent Application Publication
(10) Pub. No.: US 2003/0172077 A1
(43) Pub. Date: Sep. 11, 2003

(54) Device-independent notification system

(75) Inventor: Amir Moussavian, Rancho Santa Fe, CA (US)

Correspondence Address: PAUL, HASTINGS, JANOFSKY & WALKER LLP, P.O. BOX 919092, SAN DIEGO, CA, 92191-9092, US

(73) Assignee: MIR3, Inc.

(21) Appl. No.: 10/094,601

(22) Filed: Mar. 8, 2002

(51) Int. Cl. G06F 7/00

(52) U.S. Cl. 707/100

(57) ABSTRACT

A device- and data source-agnostic messaging and notification system receives input events and issues notifications and actions in accordance with predefined rules. The notifications target one or more recipients, each of whom may be associated with several end-user devices, i.e., means of message delivery. The messages are adapted to the end-user devices and sent to the devices in accordance with a preprogrammed delivery scheme. If the messages are not acknowledged by the end-user, they escalate in importance and propagate to a higher level of authority, in accordance with a preprogrammed escalation sequence.

### COMPUTER PROGRAM LISTING APPENDIX

Two identical compact discs (CDs) are being filed with this document. Their content is hereby incorporated by reference as if fully set forth herein. Each CD contains files of computer code used in a non-limiting embodiment of the invention. The listing of the files on each CD is located in the File Listing Appendix at the end of the specification.

### COPYRIGHT NOTICE

The copyrighted Computer Program Listing Appendix filed with this patent document forms part of the disclosure of the specification. Therefore, a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates generally to messaging services, and, more particularly, to a universal messaging platform that processes external events and generates and delivers event-based messages to end-users.

2. Background

With the proliferation of telecommunication services, many new devices for connecting people and systems have become available. The various devices and their associated methods of message delivery may not be directly compatible with each other. Often, a message can be sent to a person through several different devices, some of which are compatible with each other (e.g., different telephone numbers), and some are incompatible with each other (email and fax). Consider, for example, the contact information for which fields are reserved in Microsoft Corp.'s Outlook™ contacts list: (1) a business telephone number, (2) a home telephone number, (3) a facsimile number, (4) a mobile telephone number, (5) an email address, and (6) a web page address. In addition to the devices associated with these entries, a person (“contact”) can have other means for receiving and sending messages. For example, the person can use text and voice messaging services, a wireless personal digital assistant (PDA) device and a communication device used for email redirection, such as the Blackberry device. This list of communication devices is far from exhaustive, and the contact may be associated with multiple devices of the same kind.

In this complex and diversified communication environment, a number of universal messaging services have evolved. Typically, a universal messaging service allows a subscriber to check a single device for new messages. The subscriber can also have the messages consolidated for retrieval through the device, within certain limits. Known universal messaging services, however, do not provide a way to deliver a message in real-time when the original addressee at a particular device does not respond to the message.

Messaging is becoming increasingly important to enterprise management because situations that require action can arise at any time, regardless of the business hours at a particular location. People must be contacted, decisions must be made, responsive actions must be taken in a 24-7 universe. In this context, messaging that is limited to the conventional model of person-to-person communications using one or even several communication devices is unduly restrictive. A message originator may have to communicate to a group of people, and the originator may not even know the appropriate person or group to be contacted. The particular person to whom the message is sent may not respond to the message, or may not respond timely, particularly if the message is transmitted to only one device.

Indeed, the intended recipient of the message may not be a person, but rather a machine or a process. Similarly, a message may be automatically generated by a machine or a process. Automatic message generation and delivery services suffer from some of the same shortcomings as the conventional person-to-person messaging services. In addition, automatic message generation and delivery services suffer from the lack of interactive message delivery.

A need therefore exists for an automated way to transmit messages and to trigger appropriate actions in accordance with predefined schemes, so that the unavailability of a particular device-addressee combination does not prevent a timely and appropriate response to the message senders. Furthermore, a need exists for interactive information delivery technology that enables real-time monitoring of business activity across an enterprise's value chain.

### SUMMARY

A delivery device- and data source-agnostic notification system comprises listeners that receive data from external sources and convert the external data into a format accessible by a rule processor. The rule processor applies logic rules to the data and creates one or more events when a rule is triggered. An initializer process receives the events and creates data files corresponding to the events. A dispatcher process, which is coupled to the database of the system, also receives the events. The dispatcher determines a current escalation level corresponding to each event from the set of data comprised in the event and an escalation sequence, stored on the database, that corresponds to the event. A router determines the recipients of the messages associated with the event based on the current escalation level and the event data. The router also constructs event-related messages for each of the recipients and includes in the messages the information from the data file created by the initializer. A message builder supplements the messages with per-recipient personalized content from the database and transmits the messages to the delivery manager. The delivery manager determines the appropriate delivery devices of the recipients of the messages from the data stored in the database. Finally, a plurality of device connectors convert each of the messages into a format associated with the delivery device to which the message will be sent, and send the messages to the recipients at the delivery devices.

### BRIEF DESCRIPTION OF THE DRAWINGS

The present invention will be explained, by way of examples only, with reference to the following description, appended claims, and accompanying figures where:

FIG. 1 represents a high-level schematic diagram of a messaging system in accordance with the invention;

FIG. 2 shows the structure of a representative message file in XML;

FIG. 3 is a flowchart of the process of placing a telephone call from a messaging system in accordance with the invention;

FIG. 4 illustrates an example of the process of delivery device prioritization performed by a messaging system in accordance with the invention; and

FIG. 5 illustrates an example of an escalation process performed by a messaging system in accordance with the invention.

### DETAILED DESCRIPTION

Overall Architecture and Functionality

One embodiment of the invention is a platform- and protocol-independent, communication device-agnostic messaging and notification system. The system conforms to the Java 2 Enterprise Edition (J2EE) platform specification, and runs under an “application server” that provides an operating environment for the system's components. The compliance with the J2EE specification allows the system to run under any J2EE-compliant application server, such as BEA Systems, Inc.'s WebLogic™, IBM Corp.'s WebSphere™, JBOSS^{SM}, and Tomcat Java™.

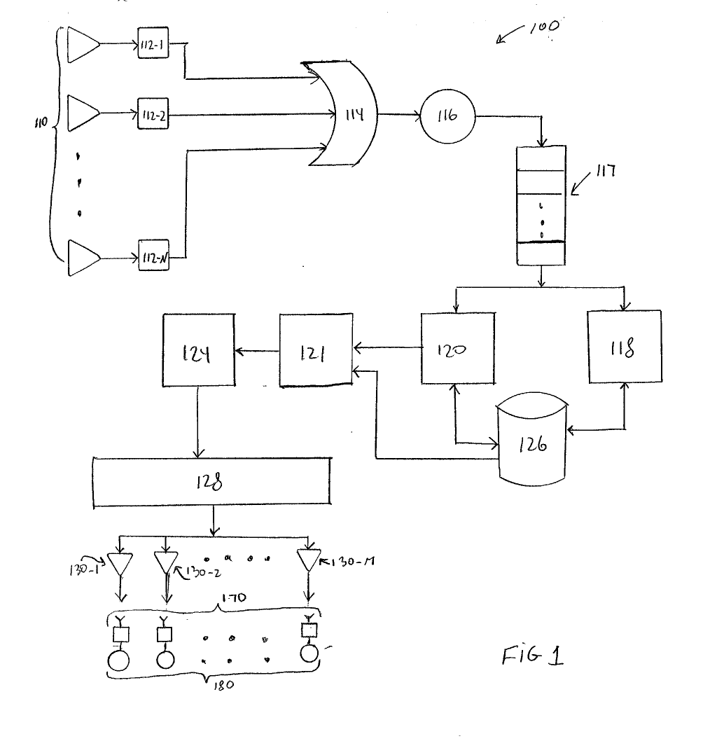

FIG. 1 is a high-level schematic representation of this non-limiting embodiment. The figure does not show many of the system's hardware and software modules, and omits many of the system's physical and logical connections.

Data enters the system 100 from any of the multiple data sources 110. The data sources may but need not be atomic. In other words, the data input may have been intercepted before delivery to the system 100, and the data may have been preprocessed before the data were forwarded to the system 100.

Listeners 112-1 through 112-N operate as the ears of the system 100: they accept the data from the external sources 110 and translate the data into a format compatible with the common interface 114. Examples of listeners include an instant messenger server, a web server, an email server, and a telephone voice mail system. The common interface 114 allows new listeners to be attached to the system 100 with relative ease, thereby improving scalability of the system 100.

The translated data are input into a rule processor 116, which applies a number of predefined logic rules to the data changes. If a change in the data satisfies the conditions of any of the rules, the rules are triggered and the rule processor generates events corresponding to the triggered rules. In this context, an event is a set of logic data prescribed by the triggered rule based on the translated data. A few example of rules and their trigger events are listed below:

(1) receipt of an email addressed to jsmith@abcdomain.com;

(2) receipt of a voice mail message at a telephone extension 567;

(3) crashing of a server computer;

(4) a response to a database query indicating that the unfilled order queue exceeds 1,000 entries;

(5) the price of a financial instrument or a commodity moving by a predetermined percentage or exceeding a preset price; and

(6) a news wire story containing predefined key expressions.

Generally, a rule has the logic form of <If Condition Then Consequence>. Preferably, the rules are evaluated using a forward chaining technique, so that the conditions that are not affected by a data change, do not get reevaluated as a result of the change. For example, if a rule has the logic form of

<If ((x>par1) and (y==par2)) Then conseq1>

and the variable x changes, then the second condition (y ==par2) is reevaluated only if the result of the evaluation of (x>par1) has changed.

In the described embodiment, the rules and conditions are defined using a scripting language similar to JavaScript™, but also providing for maintenance of histories of the values of variables. The use of the scripting language allows end-users 180 of the system 100 to have the option of programming their own messaging rules.

Consequences of rule triggering belong to two broad and somewhat overlapping groups: (1) Notifications, and (2) Actions. Notifications are essentially messages propagated to the end-users of the system 100. Actions, discussed further below, are commands issued by the system 100 to systems or devices that are logically external to the system 100. A Consequence may include both Notifications and Actions. Thus, when a server crashes, an email to the users of the server can be broadcast in parallel with sending of a “reboot server” command to the server.

After the rule processor generates an event, the event is passed to an incoming event queue 117. The events are read from the queue by an event initializer message-driven bean (MDB) 118, which also creates a new file for each event in the common XML format, and writes the new file to a database 126. Meanwhile, a monitor dispatcher 120, running in its own thread, reads the event's state, writes an escalation state or level to the database 126 (escalation is discussed at a later point), and calls a router 121. For Notifications, the router 121 first identifies the user group subscribed to the triggered rule by reading the list of the group's members from the database 126. Next, the router 121 constructs a message containing appropriate end-user information for each intended end-user. For Actions, the router 121 composes appropriate commands. For example, the router 121 may compose a command that would cause a server to be rebooted.

From the router 121 the messages are forwarded to the message builder 124. The message builder 124 adds the text of the message body, which may include personalized content that differs from one end-user to another. For example, one member of the end-user group may receive his message in French, while another member may receive her message in English. As another example, the message builder 124 can add driving directions to each member's message based on the member's geographic location. The added text also comprises some of the information in the file created by the vent initializer 118.

The message builder 124 may also comprise a content analyzer capable of characterizing and categorizing the messages based on their content. For example, the content analyzer can employ an artificial intelligence processor that differentiates among various kinds of otherwise unlabeled content of the messages. Some of the characterized messages can be archived. For example, the enterprise can program the system 100 to select for archiving the messages that have significant content and that originate from the customer service department. The archived messages can be included in the frequently asked questions (FAQ) document, and reused when the system automatically answers the customers' help requests. Messages that have not been categorized, or messages with content that is not significant, can be deleted.

Once the recipient and content of each message have been determined, the message is sent to delivery manager 128.

The delivery manager 128 looks up the list of delivery devices associated with each end-user, and selects the appropriate device or devices for a delivery attempt at the initial stage of the delivery process. The lists of the devices and other delivery information are stored on the database 126. Filtering of the messages (discussed in more detail later) can also be performed at this stage of the delivery process.

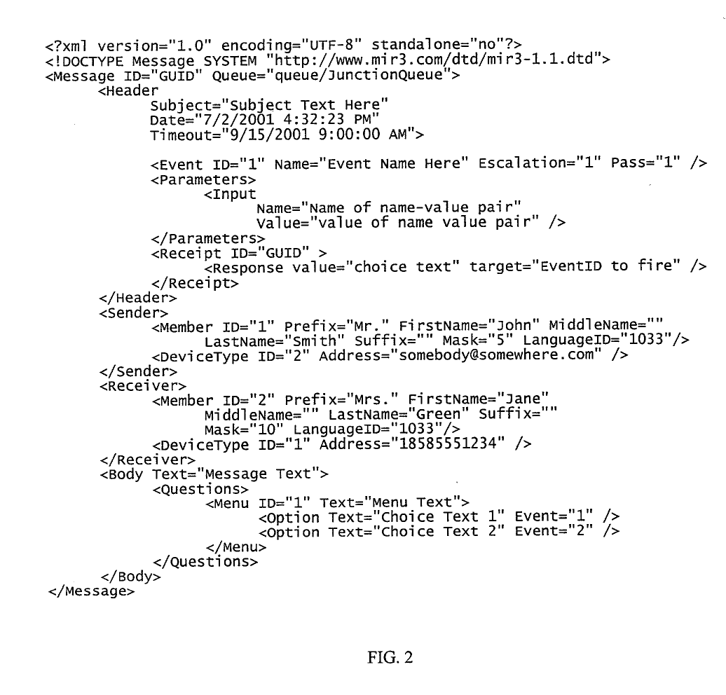

Finally, the delivery manager 128 forwards each message to at least one of device connectors 130-1 through 130-M. The device connectors 130 convert message data internal to the system 100 into a format suitable for the device to which the message is sent. For example, a message sent to a telephone may be translated into a file conforming to VoiceXML 1.0, a markup language designed for creating audio exchanges with digitized or synthesized speech. Preferably, the interface implemented for data interchange between the delivery manager 118 and the device connectors 130 uses the same format for all, or at least most, of the device connectors, because a common format allows the system 100 to be easily extended to new end-user devices 170. In the described embodiment, the common format is the Extensible Markup Language (XML). FIG. 2 illustrates the structure of a representative XML message file.

Recall that Consequences include not only Notifications (messages) discussed immediately above, but also Actions. Actions are performed by action pieces. Action pieces (not illustrated in FIG. 1) are programs that can be invoked to perform tasks outside of the system. The action pieces themselves perform tasks on some of the external processes; alternatively, the action pieces issue commands directing the external processes to act in a predetermined way. An example of an Action is a command to update a legacy database. Another example of an Action is a command to reboot a server. Action commands can be composed by the message builder 124, or by a dedicated process.

In the described embodiment, the system 100 communicates with some action pieces directly through the common XML interface. More generally, the Actions can be issued by some of the device connectors 130, which can be implemented in hardware, software, or as a combination of the two.

Note that both Actions and Notifications can be issued as a result of a single event. For example, the event of a server crashing may generate an email message to the system's administrator (a Notification), and a command to reboot the server (an Action).

Filters

The filters applied by the delivery manager 128 can be general purpose filters for adapting a specific message to a particular delivery device 130. For example, a filter can remove bulky graphic file attachments from the messages sent to wireless communication devices, delivering only the textual content of the bulky files. The filter can also divert the attached files to another device of the end-user, or to a device of the end-user's secretary.

Additionally, end-users can create their own filters to filter out messages based on, for example, the content of the subject lines, the presence of certain keywords in the body of the messages, or the identities of the message senders. A filter can apply to all messages sent to a particular end-user, or it can apply only to the messages sent to specific devices of the end-user.

Another kind of filter is a geographic filter. It is based on the system's knowledge of an end-user's real-time location. This knowledge can come from, for example, a global positioning system (GPS) receiver built into the end-users' mobile communication devices. By using the GPS information from each member of the recipient group, messages can be routed only to a geographically distinct subset of the group. In conjunction with the knowledge of the members' schedules and other information affecting their availability, the system 100 can identify the optimal member or members of the group to respond to a particular event. For example, the optimal member may be the nearest available member of the group.

Data Input Devices

In the described embodiment, the sources of the data include (1) email messages received by an email server, (2) instant messages received by an IM server, (3) calls from an application programming interface (API), (4) responses to database queries, (5) http packets from a wide area network, (6) output of a file system, (7) SNMP traps received by a network agent, and (8) audio messages received from a telephone. Furthermore, the system can accept input from most wireless or internet-connected devices. Indeed, the system 100 is designed for flexibility, and can be readily connected to additional data input sources. The system 100 is thus data source-agnostic.

End-User Connectivity Devices

Similarly, many kinds of end-user devices are compatible with the system 100 because of the presence of the multiple device connectors 130. The system 100 is therefore communication device-agnostic. Some of the device connectors 130 are briefly explained below.

Telephone

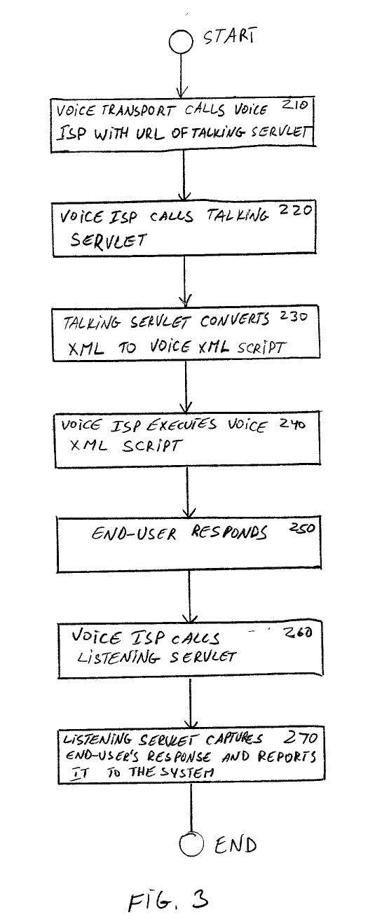

In the described embodiment, the telephone device connector is implemented as a Java Message Service (JMS) Message-Driven Bean designated as VoiceTransport. FIG. 3 illustrates the process of sending a telephone message—i.e., placing a telephone call—through VoiceTransport. Initially, VoiceTransport receives the contents of a telephone message in XML from the delivery manager 128. At step 210, VoiceTransport calls a Voice Internet Service Provider (Voice ISP) with the Uniform Resource Locators (URLs) of a talking servlet and a listening servlet that are part of the system 100. At step 220, the Voice ISP places a call to the end-user. If the call is successfully placed, Voice ISP invokes the talking servlet at step 230, to convert the XML message into VoiceXML, which then transmits the VoiceXML script to the Voice ISP.

The talking servlet performs voice conversion using the standard XSLT technology, such as the XSLT Processor Xalan. Preferably, the talking servlet uses stylesheets in the course of the voice conversion to allow easy customization of the content of the VoiceXML message.

Next, Voice ISP executes the received VoiceXML script, at step 240, and awaits the response of the end-user, provided in step 250. After receiving the response of the end-user, Voice ISP forwards the user's response to the listening servlet. This corresponds to step 260 in FIG. 3. At step 270, the listening servlet listens to the user's voice response and reports the response to the system 100. A voice recognition algorithm or a dual tone multi-frequency (DTMF) recognition algorithm interprets the end-user's response. The algorithm may be a part of the listening servlet, or it may reside elsewhere within the system 100.

Instant Messenger Connector

The instant messenger device connector is an applet that employs the TCP/IP protocols to pass messages between the end-users of the system 100. In the described embodiment, the instant messenger applet of an end-user's device displays a list of other end-users who belong to the same group and are logged into the system. If a message is sent to the end-user, it appears in the end-user's instant messenger web page.

Email Connector

This device connector sends email messages using the JavaMail™ service of the application server. Common end-user communication devices supported by the connector include the Blackberry, Raspberry, and iPaq wireless devices.

If a device to which an email message is sent supports the transmittal of meta information within a separate field, then the email connector encrypts and encodes the meta information specific to the system 100 within the message's ID. If the device does not support the transmittal of meta information in a separate field (the Blackberry device, for example), the meta information is appended to the subject field of the email message. In this way, the meta information travels “round trip” when the recipient responds to the email message using the “reply” button.

Note that when an end-user replies to an email message, the email message is received in an account monitored by the system. An email listener (one of the listeners 112) reads the reply from the system's email folder and sends the end-user's response to the system. In other words, the end-user's responsive email becomes a data change inputted into the rule processor 116 of the system 100. The reply message is therefore a potential event trigger. The meta information is extracted from the email message, together with other information within the message, and processed in accordance with the applicable rules.

Short Messaging Service

In the described embodiment, the Short Messaging Service (SMS) device connector sends SMS-conforming text messages to end-users through an SMS gateway. One example of an SMS gateway is the “SimpleWire” service, available from http://www.simplewire.com at the time of filing of this document. SMS messages are generally sent to GSM-capable wireless telephones. The SMS standard limits the messages to 160 characters in standard mode, and to 224 characters in 5-bit mode. Carriage return characters are removed automatically from the content sent through the SMS.

Delivery Device Prioritization

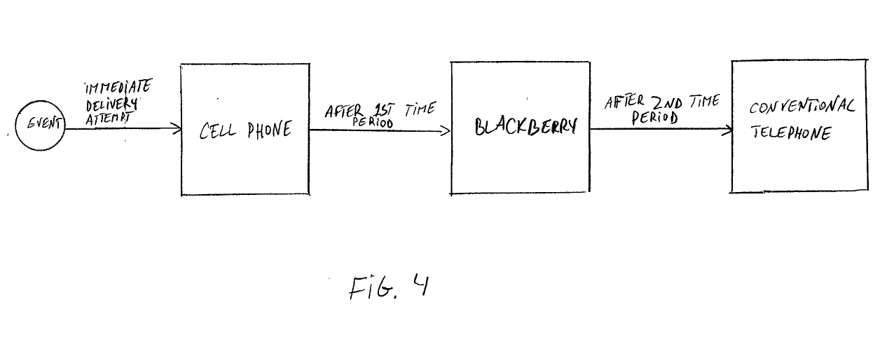

The described embodiment allows an end-user (or another person with appropriate system access privileges) to assign a priorities to the devices on which the end-user wants to receive messages. For example, the end-user may assign the highest priority to a cell telephone, the second-highest priority to a Blackberry device, and the lowest priority to a conventional telephone. Under these priority selections, the system will initially try to deliver a message to the user through the cell telephone. If the end-user does not respond within a first time period (which may be specified by the end-user), the same message will be sent to the user's second priority device, i.e., the Blackberry. If the end-user does not respond within a second time period, the message will be sent to the lowest priority device, i.e., the conventional telephone. This process is illustrated in FIG. 4.

Note that multiple devices may be assigned the same priority level. In that case, the system will simultaneously attempt to deliver the message to the multiple devices with equal priority level assignments.

Escalation Process

The described embodiment allows the enterprise to specify a Notification and Action escalation sequence. The escalation process is analogous to a chain of command. It is often used when a particular event is sufficiently important to warrant backup procedures in case the first message sent remains unacknowledged for a predetermined period of time. (Notification acknowledgement is discussed in the next subsection of this document.)

When an event triggers a Notification, the event's corresponding escalation sequence may specify that an acknowledgement of the Notification must be received within a predetermined time period. If no acknowledgement (or another event specified in the escalation sequence) takes place within the predetermined period, the escalation process advances to the next level. At the next level, the system 100 can issue the message to a secondary person or group. If the secondary person or group also fails to acknowledge the message within a predetermined time period, the escalation process may advance once again, and so on until someone acknowledges the message or the escalation sequence ends.

Note that the escalation process may be active in parallel with the delivery device prioritization process. Thus, a Notification may rise to a second level of the escalation sequence while the prioritization process is still attempting to deliver the first message generated by the Notification.

Escalation levels are not limited to Notifications, but may also include Actions. Going back to the example where the pertinent event is the crashing of a server, the event may initially trigger a message to the on-duty member of the enterprise's information technology (IT) department. If the message remains unacknowledged after 15 minutes, the escalation sequence associated with the event may cause a message to be sent to the head of the IT department. If the messages remain unacknowledged 30 minutes after the server crash, the final step in the escalation sequence may be issuing of a “reboot server” command. In this example, the escalation sequence includes two levels of Notifications and one level of Action.

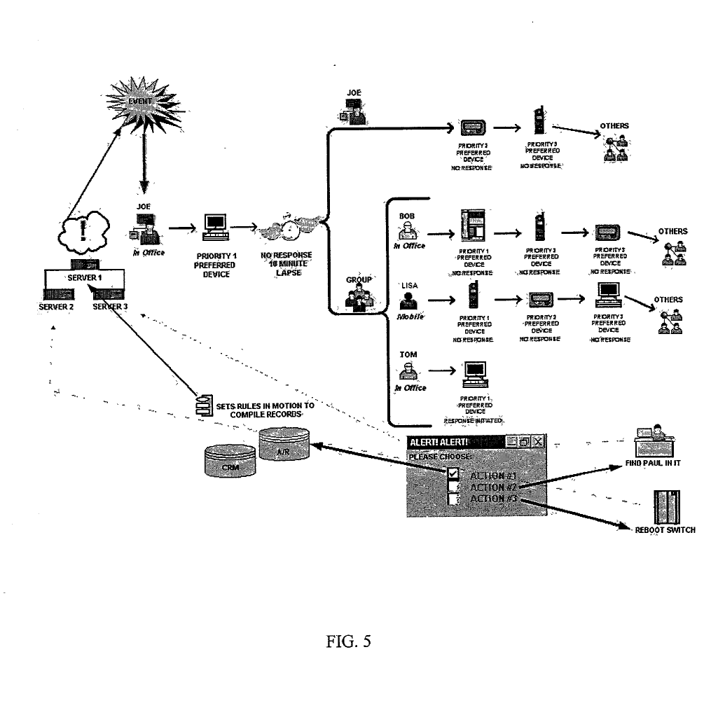

Another example of an escalation process is illustrated in FIG. 5.

Notification Acknowledgement

When the system 100 sends a message to a user, it may be desirable for the system to know whether the user received the message. For operation of some features of the system 100, such knowledge may be necessary or highly desirable. As discussed above, the prioritization and escalation processes rely on such knowledge in deciding whether to send the message to alternative devices, and whether to advance to a new level in the escalation sequence. Consequently, the described embodiment asks the end-users to acknowledge the messages, unless acknowledgement is automatically provided when the message is delivered. The end-users are asked to acknowledge the messages whether or not they intend to act in response to the messages.

In the case of a telephone message, the acknowledgement process is often automatic because the system 100 can sense a busy number signal, no answer, or a recorded answer. In the case of an email message, acknowledgement may also be automatically generated when the email message is opened. More often, the system 100 asks the end-user to acknowledge the message explicitly, for example, by replying to it with an empty message body. The acknowledgement reply triggers an event that, for example, halts the prioritization and escalation processes.

In operation, the email acknowledgement mechanism works as follows. The messages carry meta information that is automatically included in reply messages. When an end-user replies (e.g., by clicking on the “Reply” button of an email interface), the system know to which message the user is replying from the meta information included in the reply message. The meta information thus provides context to reply messages.

Interactive Mode

The system 100 of the described embodiment can carry out a dialog with an end-user. For example, the system 100 can send an end-users a news item and a question related to the news item. The end-user's reply is then captured and processed, creating an event. Depending on the reply, the event can trigger a follow-up question.

Assume, for example, that a stock ticker operates as a data source. The data source sends share price data to the system 100, which has a rule that triggers an event when the share price of ABCD stock reaches seven dollars. An interested end-user subscribed to this rule might receive a notification of this event, by telephone or email, with a question giving the end-user several options. The message exchange between the end-user and the system 100 might proceed as in the following dialog:

System 100:

ABCD stock is at seven dollars a share.

What would you like to do?

Option 1: Buy more shares.

Option 2: Sell some shares.

Option 3: Do nothing at this time.

Please reply to this message to acknowledge receipt.

End-User:

Option 1.

System 100:

You have indicated you wish to buy ABCD shares.

How many shares would you like to buy?

Option 1: Buy one thousand shares.

Option 2: Buy five thousand shares.

Option 3: Buy ten thousand shares.

Option 4: Enter or say the number of shares to buy.

Please reply to this message to acknowledge receipt.

In the case of an email message, the user may respond with some distinctive word or phrase from the given options. Unrecognized replies may be returned to the sender. In the above example, the user may respond to the first question with “Option 1” (as shown), or more descriptively, with a reply containing “Buy more shares” or just “Buy.”

In the case of a voice message, the options are listed and the user is asked to choose one of them by giving the number of the option, either by saying “one,” “two” or “three,” or by generating DTMF entries by pressing the telephone keys.

Had the user's original reply contained “Sell some shares,” the second message might look like this:

You have indicated you wish to sell ABCD shares.

How many shares would you like to sell?

Option 1: Sell one thousand shares.

Option 2: Sell five thousand shares.

Option 3: Sell ten thousand shares.

Option 4: Enter or say the number of shares to sell.

Please reply to this message to acknowledge receipt.

Finally, the user indicates how many shares to buy (or sell), and confirms his or her selection. The system 100 then triggers an event that causes an appropriate order to be placed. Upon receiving a confirmation of the transaction from a trading server or from a brokerage agent, the system 100 in turn confirms the transaction to the end-user, possibly as follows:

One thousand shares of ABCD stock have been purchased.

This and other dialogs can use any combination of telephone, email, and other end-user devices.

Auditor and Reporter

The auditing and reporting component processes of the system 100 record and report certain activities associated with the operation of the system 100. For example, these processes can record the changes in input data that trigger at least one rule. The reporting process can then compile histories of rule triggering for a specific rule, a subset of the rules, or all the rules. The histories describe the activity of the system, including, for example, the activity of specific end-users, with indications of each end-user's responsiveness to Notifications and the average time the end-user takes to respond to a Notification.

In the described embodiment, the auditing and reporting processes use the log4j logging output facility of the application server to track the progress of messages through the system. The reporting process then compiles reports describing what happened when a rule triggered an event, who responded to the event's Notification (and who did not respond), and the level of escalation when the Notification was acknowledged.

Analyzer and Predictor

These artificial intelligence component processes work in conjunction with the rules processor and the auditor and reporter processes to trigger “predictive events.” In the described embodiment, the analyzer and predictor apply fuzzy logic to the output of a data source and the stored history (or histories) of the data source that preceded a certain kind of events. The system learns trends in the data source values delivered to the system 100 by an external agent, and is able to anticipate, using fuzzy logic, the endpoints of sequences. If conditions and trends are comparable to the conditions and trends that preceded similar events in the past, within configurable limits, the event is predicted. Notifications relating to the event are then sent based on the prediction. Thus, interested parties can be warned that the particular event is likely to occur.

Consider the following illustrative example. A mail server experiences an unusual increase in the volume of received email, and the volume continues to grow. From previous crashes of the email server, the system 100 can predict that the server will soon crash. Thus, an early warning to the system administrator is issued, enabling the administrator to take preventive action. Note that the system 100 treats the prediction of the server crash as a separate event.

Database

In the described embodiment, the database 126 comprises, inter alia, the following sections: a look-up tables section, a member and group tables section, and an event tables section.

The look-up tables section comprises: (1) the basic information for the end-user registration process, including a Zip Code directory, a list of cities, counties, states, countries, and time zones; (2) device-specific filters; (3) a listing of end-user communication devices; (4) email transport information; and (5) language tools, including a table of character strings used in the system 100, in different languages supported by the system 100.

The member and group tables section comprises end-user-specific information, including user-defined filters, communication devices associated with individual end-users, and group membership lists.

The event tables section is used to store the event information, comprising a table of events, tables of messages associated with the events, tables of event subscribers, and the instances of the events stored by the reporter process.

Other Embodiments of the Invention

Methods and apparatuses of the present invention, or certain aspects or portions thereof, can be implemented or practiced on a computer or a plurality of computers interconnected by a network. Optionally, the methods and apparatuses of the present invention may be implemented or practiced within a networked client/server environment.

Furthermore, the methods and apparatuses may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatuses of the present invention may also be embodied in the form of program code that is transmitted over a transmission medium, for example, over electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

The inventive messaging and notification system and some of its features are described above in considerable detail for illustration purposes only. Neither the specific embodiments of the invention as a whole nor those of its features limit the general principles underlying the invention. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention, which function has been reserved for the appended claims and their equivalents, considered in conjunction with the remainder of this specification and the figures comprising a part thereof.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

I claim:

1. A notification system comprising:
a database storing information;
a rule processor capable of applying a plurality of logic rules to rule processor input data and creating events based on the rule processor input data when at least one rule of the plurality of logic rules is triggered by the rule processor input data, at least one event per triggered rule, each event comprising a set of data, said each event being associated with a consequence, each consequence comprising a notification;
a plurality of listeners, each listener being capable of receiving external input data from a data source and translating the external input data into the rule processor input data;
an initializer capable of receiving said each event created by the rule processor and creating an event data file corresponding to said each event;
a dispatcher coupled to the database, the dispatcher being capable of receiving said each event and determining a current escalation level corresponding to said each event from the set of data comprised in said each event and an escalation sequence corresponding to said each event stored on the database;
a router capable of determining one or more initial recipients of the notification associated with said each event from the current escalation level of said each event, the router being capable of constructing a message per each of the one or more initial recipients of the notification associated with said each event;
a message builder capable of supplementing each of the messages constructed by the router with personalized content from the information stored on the database, the subset of data of said each event, and the current escalation level;
a delivery manager capable of determining one or more delivery devices of said one or more initial recipients from the data stored on the database; and
a plurality of device connectors capable of converting said each of the supplemented messages into formats associated with the delivery devices of said one or more initial recipients and sending the converted messages to the delivery devices of said one or more initial recipients;
wherein the notification system sends the converted messages to the delivery devices of said one or more initial recipients in response to said each event created by the rule processor.

2. A notification system according to claim 1, wherein the database information comprises a delivery device prioritization sequence information for the one or more initial recipients, and the delivery manager determines the one or more delivery devices based in part on the current time and the delivery device prioritization sequence information for the one or more initial recipients.

3. The method for sending messages to end-users based on external data, the method comprising the following steps:
step for receiving the external data;
step for applying predefined rules to the received data to create events;
step for selecting, based on a stored escalation sequence, one or more of the end-users subscribing to the event;
step for determining, based on a stored delivery device prioritization sequence, delivery devices of the one or more of the end-users for sending messages related to the created event to the one or more of the end-users;
step for composing the messages and personalizing the messages;
step for adapting the composed and personalized messages for receipt by the delivery devices of the step for determining;
sending the adapted messages to the delivery devices of the step for determining.

4. The method of step 3, further comprising the step for selecting messages with significant content from among the composed messages, and storing the selected messages.
